(19) United States
(12) Patent Application Publication
(10) Pub. No.: US 2020/0072694 A1
(43) Pub. Date: Mar. 5, 2020

(54) REMOTE ACCESS BUILDING HEALTH MONITOR

(71) Applicant: MELINK CORPORATION, Cincinnati, OH (US)

(72) Inventors: Steve Melink, Cincinnati, OH (US); Bryan Miller, Cincinnati, OH (US); Bryan Evenson, Cincinnati, OH (US); Evan Risley, Cincinnati, OH (US)

(21) Appl. No.: 16/545,688

(22) Filed: Aug. 20, 2019

Related U.S. Application Data
(60) Provisional application No. 62/725,746, filed on Aug. 31, 2018.

(51) Int. Cl. G01L 27/00; G08B 19/00

(52) U.S. Cl. CPC G01L 27/002; G08B 19/00; G01L 27/007

(57) ABSTRACT

Methods, systems, and computer program products for monitoring a building pressurization without penetrating an envelope of a building. The system includes one or more processors and a memory coupled to the processors. The memory stores data comprising program code that, when executed by the processors, causes the system to receive at least one interior pressure signal from at least one interior pressure sensor and at least one exterior pressure signal from at least one exterior pressure sensor, where at least one of the at least one interior pressure signal and the at least one exterior pressure signal are received wirelessly. The system determines an interior pressure value based on the at least one interior pressure signal and an exterior pressure value based on the at least one exterior pressure signal. The system calculates the building pressurization based on a difference between the interior pressure value and the exterior pressure value.

### CROSS-REFERENCE TO RELATED APPLICATIONS

This application claims the benefit of U.S. Provisional Application No. 62/725,746, filed Aug. 31, 2018, which is hereby incorporated by reference herein in its entirety.

### BACKGROUND

The invention generally relates to devices and systems for remotely monitoring building health, and in particular to devices and systems for monitoring building pressure without penetrating a physical envelope of a building.

Building pressure is a key measurement for determining if a facility is in proper balance. Because restaurant, supermarket, and hotel buildings often have large exhaust systems to prevent fouling of the environment of the facility, e.g., for kitchen hoods, dishwashers, and restrooms, such buildings are especially prone to negative air pressure caused by over-exhausting, a condition in which there is more exhaust air than make-up air. Negative air pressure may result in outside air being drawn into the building whenever customers, employees, or vendors enter or leave the building. Depending on the temperature and humidity of the outside air, the outside air drawn in by the negative air pressure may burden the building heating and ventilation or air conditioning systems (HVAC) with compensating for temperature differentials between conditioned air and outside air, as well as causing inhabitants of the building discomfort (e.g., warm or cold drafts). Furthermore, humid outside air drawn into the building may contribute to numerous other problems, such as sweating floors that may pose slip and fall risks, condensate dripping into patrons' dinners, warping of wood floors/facades, and potential mildew/mold issues. Although a typical building is designed with a slight positive air pressure, a lack of proper HVAC maintenance (e.g., clogging of an outside air filter, stretched belts slipping on their motor/fan pulleys, etc.) may cause the building pressure to go negative over a course of time. For example, a building's thermostat may set building fans to auto mode, shutting down the fans from bringing in critical outside air whenever the inside temperature is satisfied.

Often having a portfolio of physical locations to maintain, building facility managers may have a difficult time knowing when any particular physical location is exhibiting symptoms resulting from negative air pressure that could result in substantial damage to the particular location due to excessive humidity, poor air balance, poor comfort, and/or high CO2 levels. The traditional method of measuring building pressure is with a pressure differential sensor, but permanently installing a pressure differential sensor is typically a costly endeavor. For example, in order to obtain multiple pressure differential measurements over a long period of time, a time-consuming and costly penetration through the physical building envelope (e.g., drilling through one or more exterior walls of the building to measure the pressure difference between indoors and outdoors) would likely be necessary. Moreover, permanently installed pressure differential sensors may experience accuracy deviations resulting from drift (e.g., over varying temperatures) and/or falling out of calibration over time.

Thus there is a need for a pressure differential measurement system that can be installed without penetrating a building's physical envelope and is capable of providing accurate pressure differential measurements over an extended period of time.

### SUMMARY

According to some embodiments of the invention, a method, system, and computer program product is provided of monitoring building pressurization without penetrating an envelope of a building. In embodiments, a pressure signal is received from multiple pressure sensors, including one or more pressure sensors located in an interior of the building and one or more pressure sensors located outside of the interior, i.e., an exterior of the building. For example, multiple exterior absolute pressure signals may be received from multiple exterior pressure sensors located on the exterior of the building and multiple interior absolute pressure signals may be received from multiple wireless absolute pressure sensors located on the interior of the building. In some embodiments, an interior pressure value is determined based on the at least one pressure signal and an exterior pressure value is determined based on the at least one exterior pressure signal. For example the interior pressure value may be based on an average of the interior pressure sensors and/or the exterior pressure value may be based on an average of the exterior pressure sensors.

In some embodiments, the building pressurization is calculated based on a difference between the interior pressure value and the exterior pressure value. In some embodiments, a building condition is identified based on the calculated building pressurization. In some embodiments, one or more corrective actions are performed based on the identification of the building condition. For example, building maintenance including the correction actions may be performed. In some embodiments, the plurality of interior pressure sensors and/or exterior pressure sensors are calibrated. In some embodiments, a difference in elevation is identified between (1) the one or more interior pressure sensors and (2) the one or more exterior pressure sensors. Moreover, the building pressurization may be based in part on the identified difference in elevation.

In some embodiments, an interior pressure sensor drift of at least one of the interior pressure sensors and/or an exterior pressure sensor drift of at least one of the exterior pressure sensors is identified. Moreover, the interior pressure value and/or exterior pressure value may be determined based on the identified interior pressure sensor drift and/or the exterior pressure value may be determined based on the identified exterior pressure sensor drift. In some embodiments, a particular interior sensor and/or a particular exterior sensor is identified as erroneous based on a deviation of a reading of the particular pressure sensor from readings of the other pressure sensors. For example, an interior pressure sensor may be identified as erroneous and the interior pressure value may be based on an average of the other interior pressure sensors. Likewise, an exterior pressure sensor may be identified as erroneous and the exterior pressure value may be based on an average of the other exterior pressure sensors.

In some embodiments, one or more humidity signals, temperature signals, and/or carbon dioxide signals may be received and the building condition is identified based on the one or more humidity signals, temperature signals, and/or carbon dioxide signals. In some embodiments, additional signals (e.g., carbon monoxide, power (kW), energy (kWh), smoke/particulates, noise, light level, and odors) may be received to further enhance the identification and/or prediction of the building condition.

The above summary may present a simplified overview of some embodiments of the invention in order to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a schematic view of a system for monitoring building pressurization consistent with embodiments of the invention.

FIG. 2 is a schematic view of an exemplary interior device of FIG. 1.

FIG. 3 is a schematic view of an exemplary exterior device of FIG. 1.

FIG. 4 is a schematic view of an exemplary computer system of FIG. 2.

FIG. 5 is a schematic view of an exemplary computer system of FIG. 3.

FIG. 6A is a chart of an exemplary building pressure signal.

FIG. 6B is a chart of an exemplary relative humidity signal.

FIG. 6C is a chart of an exemplary temperature signal.

FIG. 6D is a chart of an exemplary carbon dioxide (CO2) signal.

FIG. 7 is a flowchart illustrating an exemplary method to monitor building pressure without penetrating a physical envelope of the building.

### DETAILED DESCRIPTION

Embodiments of the invention provide systems, methods, and computer program products for monitoring a building pressurization without penetrating an envelope of a building.

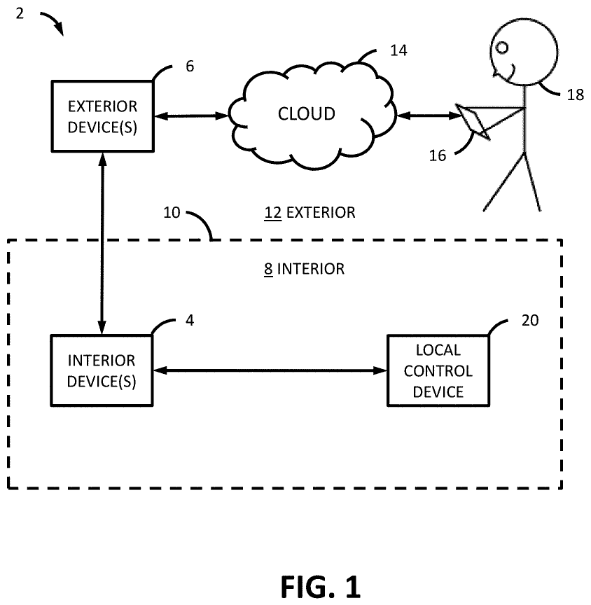

FIG. 1 illustrates a schematic view of a system for monitoring building pressurization 2, including one or more interior devices 4 in communication with one or more exterior devices 6 consistent with embodiments of the invention device. While this example illustrates a single interior device 4 in an exterior 8 of a building envelope 10 and a single exterior device 6 in an exterior 12 of the building envelope 10, the techniques disclosed herein are applicable to any number of devices/units as well as to other real world environments. Furthermore, the functions of any single device may be performed by multiple devices. In some embodiments, the one or more interior devices 4 and the one or more exterior devices 6 communicate wirelessly, for example via ZigBee®, Z-Wave®, Wi-Fi®, or Bluetooth® based wireless communication.

In some embodiments, the building envelope 10 represents the exterior walls and roof of a building (i.e., the enclosure of the building). For example, the building may be a facility such as a restaurant, hospital, or institutional facility. Furthermore, the building envelope 10 separates the inside ambient air environment of the building (e.g., interior 8) from the outside environment (e.g., exterior 12). In some embodiments, the building is equipped with an HVAC system which maintains the inside environment at a suitable condition for the use of the occupants of the building. In some embodiments, the building may include an exhaust system by which to exhaust air from the interior 8 of the building envelope 10 to the exterior 12. For example, the exhaust system may include at least one fan motor and may be associated with at least one fan by which to expel air from the exhaust assembly. In some embodiments, air exhausted by the exhaust system is replaced by air from the ambient air environment.

As shown in FIG. 1, one or more exterior devices 6 may be connected to a cloud computing system 14. In some embodiments, the cloud computing system 14 is implemented as one or more servers and the exterior device 6 is connected to the cloud computing system 14 via a communication network (e.g., Internet, a local area network (LAN), a wide area network (WAN), a cellular voice/data network, one or more high speed bus connections, and/or other such types of communication networks). In some embodiments, one or more client devices 16 are connected to the cloud computing system 14, such that a user 18 (e.g., building manager or other such building management service) may initialize a communication session with the cloud computing system 14. The client device 16 may be a personal computing device, tablet computer, thin client terminal, smart phone and/or other such computing device. In some embodiments, an interface may be generated by the cloud computing system 14 and/or client device 16 such that the user 18 (e.g., a building manager) may request or view information at the client device 16. For example, the information may include a current status of one or more parameters associated with the building, historical building data, and/or prognostic building data.

In some embodiments, as illustrated in FIG. 1, a local control device 20 may communicate with the one or more interior devices 4 and/or the one or more exterior devices 6 via a local wired or wireless connection. For example, the local control device 20 may be a handheld electronic device (e.g., a smartphone or a tablet) or a laptop computer or a desktop computer. In some embodiments, the local control device 20 has a touchpad and, in some embodiments, the local control device 20 has a touch-sensitive display. In some embodiments, the local control device 20 has a graphical user interface (GUI), one or more processors, memory and one or more modules, programs or sets of instructions stored in the memory for performing multiple functions. In some embodiments, the local control device 20 presents an interface in which build data and/or configuration data is presented on a display of the client device 16 and the user 18 interacts with the interface through finger contacts and gestures on the touch-sensitive surface.

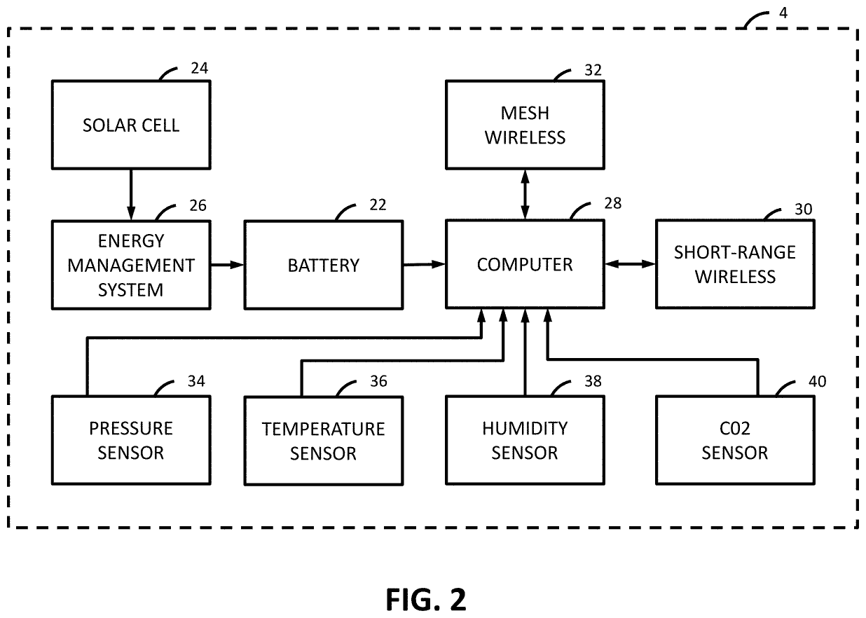

FIG. 2 illustrates a schematic view of an exemplary interior device 4. In some embodiments, the interior device 4 is powered by a battery 22. For example, the battery 22 may be a rechargeable battery (e.g., lead-acid, nickel-cadmium, nickel-metal hydride, lithium-ion, lithium-polymer, etc.) or a primary (non-rechargeable) battery (e.g., alkaline, carbon zinc, lithium, silver oxide, zinc air, etc.). In some embodiments, the interior device 4 may be connected to a power adapter that converts alternating current (AC) mains electricity into direct current (DC) and/or a voltage compatible with the battery and/or components of the interior device 4. Power from the power adapter may then be used to charge the battery and/or supply power to components in the interior device 4. In the absence of a power adapter and/or mains electricity, the interior device 4 may be powered by the battery 22 until the battery 22 is fully discharged. Because the battery 22 has a limited runtime, operation of the interior device 4 may be dependent on the availability of mains electricity. Accordingly, the interior device 4 may include a solar cell 24 and an energy management system 26. For example, the energy management system 26 may accept power from the solar cell 24 in order to recharge the battery 22. In some embodiments, the battery 22 provides power to one or more computer devices, such as computer 28.

In some embodiments, the interior device 4 utilizes a solar cell 24 capable of harvesting energy in low light conditions of an indoor commercial building, e.g., a 250 uW solar cell in combination with a battery charger that works with a wide input voltage range. In some embodiments, the battery 22 is capable of providing up to three months of continuous operation when fully charged, although capabilities of the interior device 4 may be reduced during the three-month period if necessary. For example, the interior device 4 may utilize an ultra-low power energy harvester and battery charger. In some embodiments, the energy harvester can charge a battery with typical office lighting, and features a max power point tracking (MPPT) feature to get the most energy out of the solar cell 24. In some embodiments, the interior device 4 utilizes an amorphous silicon solar cell, e.g., which offers better indoor performance than some other commercially available solar cells. In some embodiments, the battery 22 is a rechargeable battery. Moreover, in some embodiments, a supercapacitor is used in combination with the battery 22.

In some embodiments, the computer 28 manages timing for requesting sensor data, managing messages on data busses, and communicating with other devices. For example, the computer 28 may include a real-time clock (RTC) with a calendar mode (for logging samples and for user interfacing), multiple serial ports, and low power sleep options. In some embodiments, the computer 28 is a flash-based microcontroller with self-programmable flash for performing in-system firmware upgrades. For example, the computer 28 may include at least 50% free flash space for downloading a full new firmware during the firmware upgrade process. In some embodiments, the computer 28 is an ultra-low-power microcontroller unit (MCU). For example, the computer 28 may include at least one serial peripheral interface (SPI) port, one inter-integrated circuit (I2C) port, three universal asynchronous receiver-transmitters (UARTs), and at least fifteen additional input/output (I/O) lines. As understood by one of ordinary skill in the art, the computer 28 may be chosen based on a balance of necessary features and cost. Moreover, the computer 28 may utilize an external crystal or oscillator, dependent upon the requirements for the RTC and the peripheral communication. For example, battery usage may be conserved by utilizing either a crystal or an oscillator, dependent upon the power requirements of the respective components. In some embodiments, the computer 28 includes an eZ-FET debug interface which allows debugging through a micro-USB port. For example, the debug interface may be used for debugging and programming and may be detachable from the interior device 4.

In some embodiments, the interior device includes a short-range wireless module 30. For example, the interior device 4 may not include a display, but instead use wireless communication (e.g., Bluetooth®) for communication to allow the local control device 20 to configure the interior device 4 and/or to check the status of the interior device 4. Moreover, an application installed on the local control device 20 (e.g., a smartphone) may further enable such functionality. In some embodiments, the short-range wireless module 30 utilizes a built-in antenna. For example, the short-range wireless module 30 (e.g., a Bluetooth® Low Energy (BLE) module, specification 4.2 or greater) may provide Bluetooth® operation with a range as low as ten feet since the local control device 20 can be required to be in close proximity to the interior device 4. In some embodiments, the short-range wireless module 30 includes a power-on switch enabling a user to enable or disable short-range wireless connectivity. Moreover, in some embodiments, the computer 28 may power off the short-range wireless module 30 except when requested by the user 18.

In order to communicate with other interior devices 4 and/or exterior devices 6, in some embodiments, the interior device 4 includes a mesh networking wireless communication module 32. For example, the one or more interior devices 4 and/or exterior device 6 may communicate with each other via mesh networking to relay telemetry, configuration and updated firmware. In some embodiments, the computer 28 may power off the mesh networking wireless communication module 32 when the mesh networking wireless communication module 32 is not in use.

In some embodiments, the interior device 4 includes a pressure sensor 34 to provide a pressure measurement (e.g., interior pressure). For example, a very low pressure differential (e.g., between 0.005″ water column and 0.02″ water column) between an interior pressure and an exterior pressure may be measured using microelectromechanical systems (MEMS) barometric pressure sensors. In some embodiments, an individual pressure sensor may not provide a requisite level of accuracy and precision. Moreover, in some embodiments, accuracy and precision is increased by utilizing an array of pressure sensors and averaging the readings of the array of pressure sensors. Thus, by averaging the results of the array of pressure sensors, the errors if the individual pressure sensors may average out and result in a very precise pressure reading. For example, the pressure sensor 34 may include an array of nine pressure sensors. In some embodiments, the computer 28 powers off the pressure sensor 34 when not taking pressure readings.

In some embodiments, the interior device 4 includes a temperature sensor 36. For example, the interior device 4 may use temperature measurements for calculating a pressure compensation factor. In some embodiments, the pressure sensor 34 also serves as the temperature sensor 36, i.e., the pressure sensor 34 may be a dual-purpose pressure and temperature sensor. In some embodiments, the computer 28 powers off the temperature sensor 36 when not taking temperature readings.

Because relative humidity plays a part in building comfort and maintenance, in some embodiments, the interior device 4 includes a humidity sensor 38. Furthermore, even if correct building pressure is maintained, high humidity can contribute to mold or other building damage. For example, the humidity sensor 38 may be a fully calibrated digital humidity sensor with a rated accuracy of +/−3% that operates at 1.8V and has an I2C interface. In some embodiments, the computer 28 powers off the humidity sensor 38 when the humidity sensor 38 is not taking readings.

In some embodiments, the interior device 4 includes a carbon dioxide (CO2) sensor 40, for example, an ultra-low power, low profile ambient air CO2 sensor. For example, because CO2 levels are a component of general air quality, it may be useful to utilize CO2 readings in combination with direct HVAC control to determine how much outside air needs to be used by a make-up air unit. In some embodiments, the CO2 sensor 40 is a nondispersive infrared (NDIR) type CO2 sensor with a UART interface that is physically positioned to ensure airflow past the CO2 sensor. In some embodiments, the computer 28 may power off the CO2 sensor 40 when we are not taking CO2 readings.

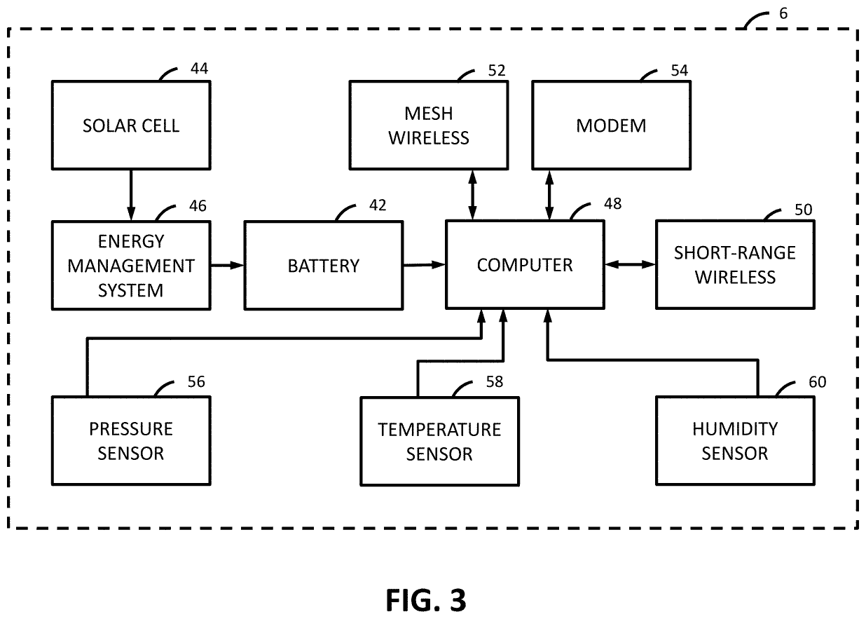

FIG. 3 illustrates a schematic view of an exemplary exterior device 6. In some embodiments, the exterior device 6 is powered by a battery 42. For example, the battery 42 may be a rechargeable battery (e.g., lead-acid, nickel-cadmium, nickel-metal hydride, lithium-ion, lithium-polymer, etc.) or a primary (non-rechargeable) battery (e.g., alkaline, carbon zinc, lithium, silver oxide, zinc air, etc.). In some embodiments, the exterior device 6 may be connected to a power adapter that converts AC mains electricity into DC and/or a voltage compatible with the battery and/or components of the exterior device 6. Power from the power adapter may then be used to charge the battery and/or supply power to components in the exterior device 6. In the absence of a power adapter and/or mains electricity, the exterior device 6 may be powered by the battery 42 until the battery 42 is fully discharged. Because the battery 42 has a limited runtime, operation of the exterior device 6 may be dependent on the availability of mains electricity. Accordingly, the exterior device 6 may include a solar cell 44 and an energy management system 46. For example, the energy management system 46 may accept power from the solar cell 44 in order to recharge the battery 42. In some embodiments, the battery 42 provides power to one or more computer devices, such as computer 48.

In some embodiments, the exterior device 6 utilizes a solar cell 24, e.g. a high efficiency solar cell optimized for outdoor use. For example, the exterior device 6 may utilize an ultra-low power energy harvester and battery charger. In some embodiments, the exterior device 6 utilizes a solar cell (e.g., monocrystalline, amorphous silicon, etc.). In some embodiments, the battery 42 is a rechargeable battery. Moreover, in some embodiments, a supercapacitor is used in combination with the battery 42.

In some embodiments, the computer 48 manages timing for requesting sensor data, managing messages on data busses, and communicating with other devices. For example, the computer 48 may include an RTC with a calendar mode (for logging samples and for user interfacing), multiple serial ports, and low power sleep options. In some embodiments, the computer 48 is a flash-based microcontroller with self-programmable flash for performing in-system firmware upgrades. For example, the computer 48 may include at least 50% free flash space for downloading a full new firmware during the firmware upgrade process. In some embodiments, the computer 48 is an ultra-low-power MCU. For example, the computer 48 may include at least one SPI port, one I2C port, three universal UARTs, and at least fifteen additional I/O lines. As understood by one of ordinary skill in the art, the computer 48 may be chosen based on a balance of necessary features and cost. Moreover, the computer 48 may utilize an external crystal or oscillator, dependent upon the requirements for the RTC and the peripheral communication. For example, battery usage may be conserved by utilizing either a crystal or an oscillator, dependent upon the power requirements of the respective components. In some embodiments, the computer 48 includes an eZ-FET debug interface which allows debugging through a micro-USB port. For example, the debug interface may be used for debugging and programming and may be detachable from the exterior device 6.

In some embodiments, the exterior device includes a short-range wireless module 50. For example, the exterior device 6 may not include a display, but instead use wireless communication (e.g., Bluetooth®) for communication to allow the local control device 20 to configure the exterior device 6 and/or to check the status of the exterior device 6. Moreover, an application installed on the local control device 20 (e.g., a smartphone) may further enable such functionality. In some embodiments, the short-range wireless module 50 utilizes a built-in antenna. For example, the short-range wireless module 50 (e.g., a BLE module, specification 4.2 or greater) may provide Bluetooth® operation with a range as low as ten feet since the local control device 20 can be required to be in close proximity to the exterior device 6. In some embodiments, the short-range wireless module 50 includes a power-on switch enabling a user to enable or disable short-range wireless connectivity. Moreover, in some embodiments, the computer 48 may power off the short-range wireless module 50 except when requested by the user 18.

In order to communicate with interior devices 4 and/or other exterior devices 6, in some embodiments, the exterior device 6 includes a mesh networking wireless communication module 52. For example, the one or more interior devices 4 and/or exterior device 6 may communicate with each other via mesh networking to relay telemetry, configuration and updated firmware. In some embodiments, the computer 48 may power off the mesh networking wireless communication module 52 when the mesh networking wireless communication module 52 is not in use.

In order to communicate with the cloud computing system 12, in some embodiments, the exterior device 6 includes a modem 54, for example, a mesh networking wireless communication module. In some embodiments, the exterior device 6 is the remote access gateway for the system for monitoring building pressurization 2. For example, the exterior device 6 may upload daily telemetry data, check for and download new firmware, send alerts and synchronize configuration. In some embodiments, the total data usage is very low and, thus, a low throughput modem and low data level Machine-to-Machine cellular plan are particularly cost effective. In some embodiments, the modem 54 has a UART interface and a simple communication structure making it possible for the exterior device 6 to easily perform TCP/IP transactions. In some embodiments, the modem 54 implements the LTE-M specification for extended power savings. In some embodiments, the computer 48 may power off the modem 54 when the modem 54 is not in use and the frequency of interaction with the modem 54 are limited in instances of poor cellular signal to avoid draining the battery 42. In some embodiments, the modem 54 is connected to an internal or external antenna.

In some embodiments, the exterior device 6 includes a pressure sensor 56 to provide a pressure measurement (e.g., exterior pressure). For example, a very low pressure differential (e.g., between 0.005″ water column and 0.02″ water column) between an exterior pressure and an interior pressure may be measured using MEMS barometric pressure sensors. In some embodiments, an individual pressure sensor may not provide a requisite level of accuracy and precision. Moreover, in some embodiments, accuracy and precision is increased by utilizing an array of pressure sensors and averaging the readings of the array of pressure sensors. Thus, by averaging the results of the array of pressure sensors, the errors if the individual pressure sensors may average out and result in a very precise pressure reading. For example, the pressure sensor 56 may include an array of nine pressure sensors. In some embodiments, the computer 48 powers off the pressure sensor 56 when not taking pressure readings.

In some embodiments, the exterior device 6 includes a temperature sensor 58. For example, the exterior device 6 may use temperature measurements for calculating a pressure compensation factor. In some embodiments, the pressure sensor 56 also serves as the temperature sensor 58, i.e., the pressure sensor 56 may be a dual-purpose pressure and temperature sensor. In some embodiments, the computer 48 powers off the temperature sensor 58 when not taking temperature readings.

Because tracking outdoor humidity allows for comparison with humidity measured by the interior device 4, in some embodiments, the exterior device 6 includes a humidity sensor 60. For example, the humidity sensor 60 may be a fully calibrated digital humidity sensor with a rated accuracy of +/−3% that operates at 1.8V and has an I2C interface. In some embodiments, the computer 48 powers off the humidity sensor 60 when the humidity sensor 60 is not taking readings.

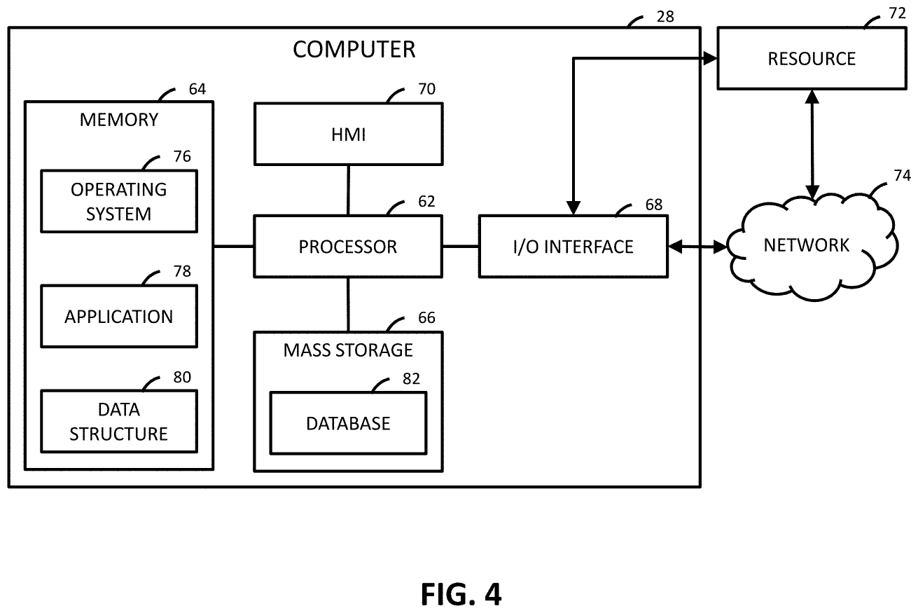

With reference to FIG. 4, the computer system of the interior device 4 may be implemented on one or more computer devices or systems, such as exemplary computer 28. The computer 28 may include a processor 62, a memory 64, a mass storage memory device 66, an input/output (I/O) interface 68, and a Human Machine Interface (HMI) 70. The computer 28 may also be operatively coupled to one or more external resources 72 via the communication network 74 or I/O interface 68. External resources 72 may include, but are not limited to, servers, databases, mass storage devices, peripheral devices, cloud-based network services, or any other suitable computer resource that may be used by the computer 28.

The processor 62 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 64. The memory 64 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 64 may include data storage devices such as a hard drive, optical drive, tape drive, non-volatile solid state device, or any other device capable of storing information.

The processor 62 may operate under the control of an operating system 76 that resides in the memory 64. The operating system 76 may manage computer resources so that computer program code embodied as one or more computer software applications, such as an application 78 residing in memory 64, may have instructions executed by the processor 62. In an alternative embodiment, the processor 62 may execute the application 78 directly, in which case the operating system 76 may be omitted. One or more data structures 80 may also reside in memory 64, and may be used by the processor 62, operating system 76, or application 78 to store or manipulate data.

The I/O interface 68 may provide a machine interface that operatively couples the processor 62 to other devices and systems, such as the communication network 74 or the one or more external resources 72. The application 78 may thereby work cooperatively with the communication network 74 or the external resources 72 by communicating via the I/O interface 68 to provide the various features, functions, applications, processes, or modules comprising embodiments of the invention. The application 78 may also have program code that is executed by the one or more external resources 72, or otherwise rely on functions or signals provided by other system or network components external to the computer 28. Indeed, given the nearly endless hardware and software configurations possible, persons having ordinary skill in the art will understand that embodiments of the invention may include applications that are located externally to the computer 28, distributed among multiple computers or other external resources 72, or provided by computing resources (hardware and software) that are provided as a service over the communication network 74, such as a cloud computing service.

The HMI 70 may be operatively coupled to the processor 62 of computer 28 in a known manner to allow a user to interact directly with the computer 28. The HMI 70 may include video or alphanumeric displays, a touch screen, a speaker, and any other suitable audio and visual indicators capable of providing data to the user. The HMI 70 may also include input devices and controls such as an alphanumeric keyboard, a pointing device, keypads, pushbuttons, control knobs, microphones, etc., capable of accepting commands or input from the user and transmitting the entered input to the processor 62.

A database 82 may reside on the mass storage memory device 66, and may be used to collect and organize data used by the various systems and modules described herein. The database 82 may include data and supporting data structures that store and organize the data. In particular, the database 82 may be arranged with any database organization or structure including, but not limited to, a relational database, a hierarchical database, a network database, or combinations thereof. A database management system in the form of a computer software application executing as instructions on the processor 62 may be used to access the information or data stored in records of the database 82 in response to a query, where a query may be dynamically determined and executed by the operating system 76, other applications 78, or one or more modules.

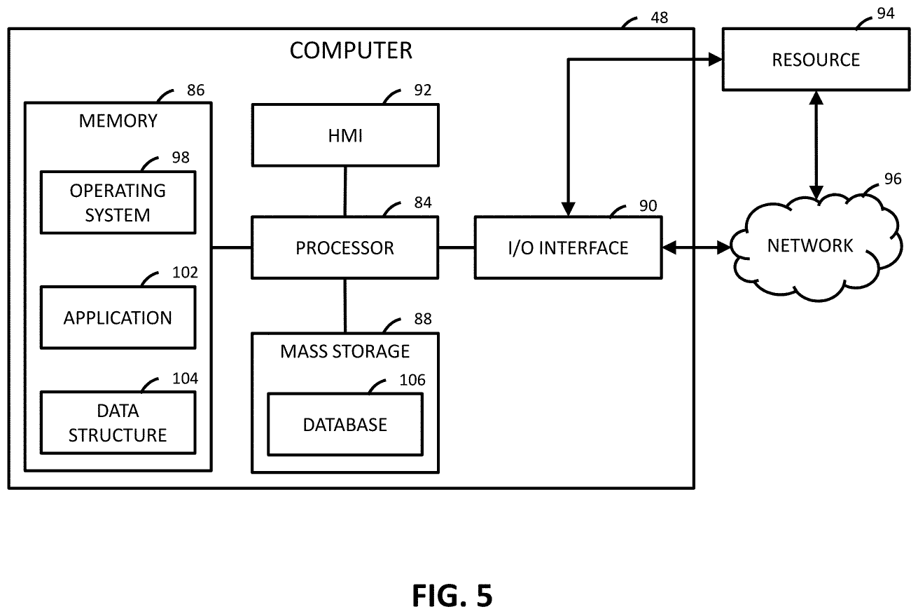

With reference to FIG. 5, the computer system of the exterior device 6 may be implemented on one or more computer devices or systems, such as exemplary computer 48. The computer 48 may include a processor 84, a memory 86, a mass storage memory device 88, an I/O interface 90, and an HMI 92. The computer 48 may also be operatively coupled to one or more external resources 94 via the communication network 96 or I/O interface 90. External resources 94 may include, but are not limited to, servers, databases, mass storage devices, peripheral devices, cloud-based network services, or any other suitable computer resource that may be used by the computer 48.

The processor 84 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 86. The memory 86 may include a single memory device or a plurality of memory devices including, but not limited to, ROM, RAM, volatile memory, non-volatile memory, SRAM, DRAM, flash memory, cache memory, or any other device capable of storing information. The mass storage memory device 88 may include data storage devices such as a hard drive, optical drive, tape drive, non-volatile solid state device, or any other device capable of storing information.

The processor 84 may operate under the control of an operating system 98 that resides in the memory 86. The operating system 98 may manage computer resources so that computer program code embodied as one or more computer software applications, such as an application 102 residing in memory 86, may have instructions executed by the processor 84. In an alternative embodiment, the processor 84 may execute the application 102 directly, in which case the operating system 98 may be omitted. One or more data structures 104 may also reside in memory 86, and may be used by the processor 84, operating system 98, or application 102 to store or manipulate data.

The I/O interface 90 may provide a machine interface that operatively couples the processor 84 to other devices and systems, such as the communication network 96 or the one or more external resources 94. The application 102 may thereby work cooperatively with the communication network 96 or the external resources 94 by communicating via the I/O interface 90 to provide the various features, functions, applications, processes, or modules comprising embodiments of the invention. The application 102 may also have program code that is executed by the one or more external resources 94, or otherwise rely on functions or signals provided by other system or network components external to the computer 48. Indeed, given the nearly endless hardware and software configurations possible, persons having ordinary skill in the art will understand that embodiments of the invention may include applications that are located externally to the computer 48, distributed among multiple computers or other external resources 94, or provided by computing resources (hardware and software) that are provided as a service over the communication network 96, such as a cloud computing service.

The HMI 92 may be operatively coupled to the processor 84 of computer 48 in a known manner to allow a user to interact directly with the computer 48. The HMI 92 may include video or alphanumeric displays, a touch screen, a speaker, and any other suitable audio and visual indicators capable of providing data to the user. The HMI 92 may also include input devices and controls such as an alphanumeric keyboard, a pointing device, keypads, pushbuttons, control knobs, microphones, etc., capable of accepting commands or input from the user and transmitting the entered input to the processor 84.

A database 106 may reside on the mass storage memory device 88, and may be used to collect and organize data used by the various systems and modules described herein. The database 106 may include data and supporting data structures that store and organize the data. In particular, the database 106 may be arranged with any database organization or structure including, but not limited to, a relational database, a hierarchical database, a network database, or combinations thereof. A database management system in the form of a computer software application executing as instructions on the processor 84 may be used to access the information or data stored in records of the database 106 in response to a query, where a query may be dynamically determined and executed by the operating system 98, other applications 102, or one or more modules.

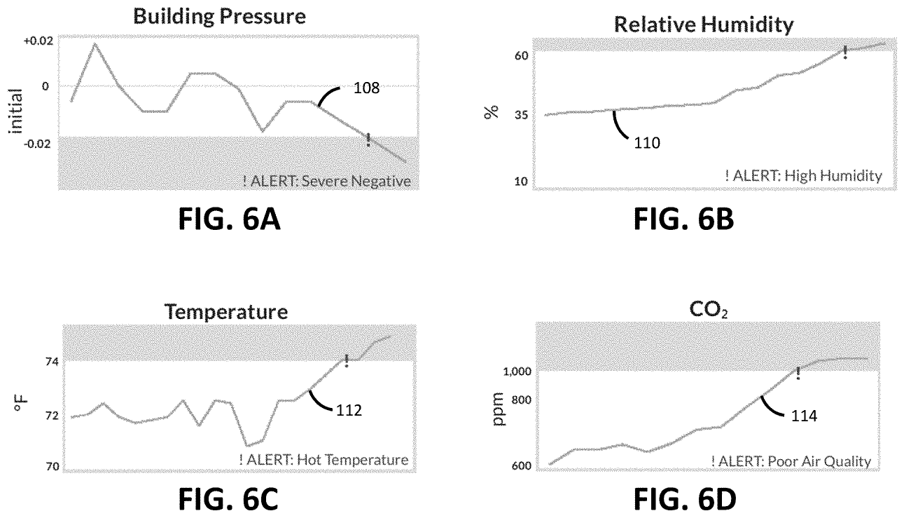

FIG. 6A is a chart of an exemplary building pressure signal 108. In some embodiments, the building pressure is calculated based on the difference between one or more readings from the pressure sensor 34 of the interior device 4 and one or more readings from the pressure sensor 56 of the exterior device 6. In some embodiments, a building condition is identified based on the building pressure. For example, an over-exhausting condition may be identified by severely negative building pressure. In some embodiments, one or more corrective actions are performed based on identification of the building condition. For example, HVAC maintenance (e.g. replacement of motors, pulleys, filters, etc.) may be performed to remedy an identified over-exhausting condition. Similarly, HVAC settings may be changed to remedy the identified building condition; e.g., setting the exhaust fan to a lower speed to accommodate for an over-exhausting condition.

FIG. 6B is a chart of an exemplary relative humidity signal 110. In some embodiments, a building's relative humidity is used, at least in part, to identify a building condition. For example, an over-exhausting condition may be at least partially identified by high building humidity, e.g., over-exhausting condition may result in large amounts of humid outside air being drawn into the building.

FIG. 6C is a chart of an exemplary temperature signal 112. In some embodiments, a building's temperature is used, at least in part, to identify a building condition. For example, a non-functional HVAC system may at least partially identified based on hot building temperatures.

FIG. 6D is a chart of an exemplary carbon dioxide (CO2) signal 114. In some embodiments, a building's CO2 level is used, at least in part, to identify a building condition. For example, in adequate building ventilation for the number of occupants in the building may be identified based on an elevated indoor CO2 concentration. In some embodiments, CO2 readings are pressure compensated and the lowest CO2 level is tracked over time.

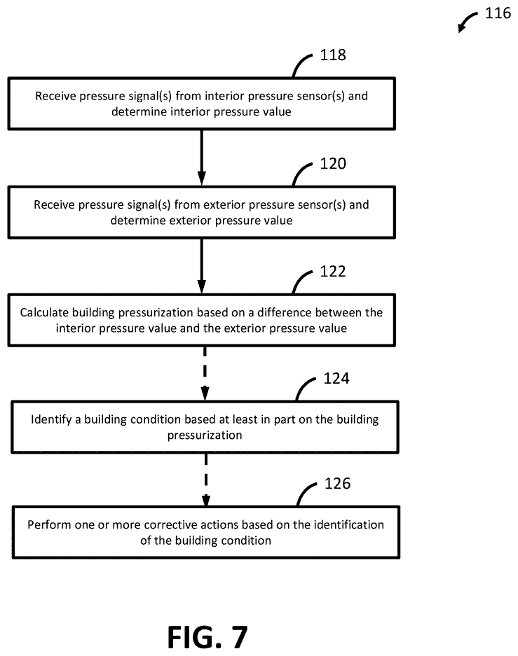

FIG. 7 is a flowchart illustrating an exemplary method 116 to monitor building pressure without penetrating a physical envelope of the building. In some embodiments, the method 116 utilizes an interior device (i.e., device located within the envelope of a building) and an exterior device (i.e., device located outside of the envelope of the building) to monitor a building's differential pressure, temperature, relative humidity and CO2 levels and reports the information to a remote server. The server then evaluates this data to determine if there are any issues with the building's HVAC and alerts the appropriate people of needed maintenance.

In some embodiments, the interior device measures the indoor temperature, relative humidity, CO2 level and the absolute pressure inside the building. The interior device may be solar-powered by the ambient indoor lighting and may have a ZigBee® router for communicating with the outdoor device. Since the indoor light energy is relatively weak, the interior device may only power up the ZigBee® router when necessary and may end the conversation if there is no response from the outdoor unit. In some embodiments, the method 116 is capable of utilizing multiple interior devices for calculating differential pressure in different sections of the building.

In some embodiments, the exterior device measures the absolute pressure outside the building. The exterior device may also measure the outdoor temperature and relative humidity. For example, the measured outdoor temperature may be used for calculating any corrections to the outdoor pressure measurements. In some embodiments, the exterior device has a cellular modem for sending sensor data to the remote server. Thus, data may be sent to the server without any interaction with a local customer internet connection. The exterior device may also be solar-powered, and with the increased energy from outdoor lighting, the exterior device may support a cellular modem and increased usage from a ZigBee® router. The exterior device may then have its ZigBee® device on for longer periods of time to further facilitate communication from the interior device(s).

In step 118 of method 116, pressure signals are received from one or more interior pressure sensors and an interior pressure value is determined. In some embodiments, the interior pressure value is based on an average of readings from an array of absolute pressure sensors. For example, several interior devices may each include an array of nine absolute pressure sensors; the interior absolute pressure signal may be based on an average of not only the each interior devices array of pressure sensors, but also of an average of the pressure readings from the multiple interior devices.

Furthermore, in some embodiments, the interior pressure sensors may be calibrated in order to account for any deviations or inaccuracies associated with a particular pressure sensor or array of pressure sensors. For example, the readings of a particular pressure sensor may be offset by an amount determined based on a deviation from an average reading of the other pressure sensors. Similarly, in some embodiments, the reading of the particular pressure sensor may be disregarded if the deviation of the particular pressure sensor exceeds a threshold deviation. For example, the interior pressure value may be determined by averaging the remainder of the pressure sensors, where the average does not include the erroneous pressure reading exceeding the threshold deviation from the average pressure reading.

In some embodiments, if one or more pressure sensors has a reading that has changed dramatically from its last reading compared to the other sensors, then its sample for that sample period is rejected. For example, the relative raw offset of each pressure sensor from the other pressure sensors may be tracked and then a mixture of Gaussians approach may be applied to determine which pressure sensors are reporting erroneous values.

In some embodiments, long-term drift effects from the pressure sensors may be identified. For example, a drift of all sensors on all devices may follow the same mean. However, if some sensor start drifting at a different rate, the readings may slowly drift and could result in false readings. By comparing daily average raw offsets, method 116 may determine which sensors are drifting further than the other sensors and apply a correction factor. In some embodiments, the method 116 may determine that a re-calibration of the sensors is required. For example, the sensors may drift far enough from each other that the method 116 can no longer confidently determine which sensors are the “good” readings and which are the “bad” readings.

In some embodiments, the interior pressure value may be determined based at least in part on a drift of pressure readings resulting from a change in temperature. For example, an increase or decrease in temperature may correspond to a drift in pressure readings.

In some embodiments, the actual absolute interior pressure may be expressed as P_{ACT}=P_{MEAS}+P_{TDRIFT}+P_{RMS}, where P_{ACT} is the actual absolute interior pressure, P_{MEAS} is the measured absolute interior pressure, P_{RMS} is the RMS noise of the interior pressure readings, and P_{TDRIFT} is a polynomial equation of the form a*(T_{REF}−T_{MEAS})²+b*(T_{REF}−T_{MEAS})+c, where a and b are unknown coefficients, c is an offset, T_{REF} is a reference interior temperature and T_{MEAS} is the interior temperature measured at the time of the interior pressure sample. In some embodiments, given the error terms in calculating P_{ACT}, P_{TDRIFT} may be orders of magnitude larger than the actual differential pressure when calculating the differential pressure between an individual interior pressure sensor and one or more exterior pressure sensors. Accordingly, it may not be possible to calculate the drift coefficients when looking at a few data points. However, in some embodiments, given that the interior and exterior pressure sensors are in fixed locations and data is sampled throughout the day under various temperature conditions, eventually the data sampling size increases for each interior temperature until the error terms follow a normal distribution.

In some embodiments, once the error terms follow a normal distribution, the differential building pressure may be calculated as P_{DIFF}=P_{IN}−P_{OUT}−P_{HOFF}, where P_{DIFF} is the calculated differential pressure, P_{IN} is the measured pressure for the interior device, Pour is the measured pressure for the exterior device, and P_{HOFF} is the differential offset between the two devices due to elevation differences. Moreover, if there were no drift due to temperature (i.e., P_{TDRIFT}=0), then a plot of differential pressure versus interior temperature would not follow a curve. Therefore, in some embodiments, the coefficients for an individual interior pressure sensor (i.e., a and b when calculating P_{TDRIFT}) can be deduced by using a multivariate linear regression model to minimize the standard deviation in the differential pressure versus interior temperature.

Although the differential building pressure may be calculated based on only a single pressure sensor on each of the interior device and the exterior device, the P_{RMS} term may still be too large to calculate a reasonable differential building pressure. Thus in some embodiments, calibration is performed on each individual interior pressure sensor and then the results are averaged, further reducing P_{RMS} and making accurate differential pressure readings possible.

In some embodiments, each interior pressure sensor has its own long term drift and commercial buildings are prone to environmental conditions that can lead to long term drift in differential pressure (e.g., dirty air filters, worn fan belts, etc.). Although there is no means to distinguish each interior sensor's long term drift due to environmental conditions when using only a single absolute pressure sensor on both the interior and exterior devices, it is possible to calculate an individual interior sensor's long term drift if there is a plurality of interior and exterior pressure sensors.

In some embodiments, long-term drift is first analyzed if an interior pressure sensor's pressure reading has drifted more than statistically expected from the mean of the plurality of interior pressure sensors. Furthermore, the system may determine whether the interior pressure sensors and the exterior pressure sensors have experienced the same long-term drift. In some embodiments, the interior pressure sensor's offset is adjusted to remove any calculated long term drift from the interior pressure sensor's pressure readings.

In step 120 of method 116, pressure signals are received from one or more exterior pressure sensors and an exterior pressure value is determined. In some embodiments, the exterior pressure value is based on an average of readings from an array of absolute pressure sensors. For example, several exterior devices may each include an array of nine absolute pressure sensors; the exterior absolute pressure signal may be based on an average of not only the each exterior devices array of pressure sensors, but also of an average of the pressure readings from the multiple exterior devices.

Furthermore, in some embodiments, the exterior pressure sensors may be calibrated in order to account for any deviations or inaccuracies associated with a particular pressure sensor or array of pressure sensors. For example, the readings of a particular pressure sensor may be offset by an amount determined based on a deviation from an average reading of the other pressure sensors. Similarly, in some embodiments, the reading of the particular pressure sensor may be disregarded if the deviation of the particular pressure sensor exceeds a threshold deviation. For example, the exterior pressure value may be determined by averaging the remainder of the pressure sensors, where the average does not include the erroneous pressure reading exceeding the threshold deviation from the average pressure reading.

In some embodiments, the exterior pressure value may be determined based at least in part on a drift of pressure readings resulting from a change in temperature. For example, an increase or decrease in temperature may correspond to a drift in pressure readings.

In some embodiments, the actual absolute exterior pressure may be expressed as P_{ACT}=P_{MEAS}+P_{TDRIFT} P_{RMS}, where P_{ACT} is the actual absolute exterior pressure, P_{MEAS} is the measured absolute exterior pressure, P_{RMS} is the RMS noise of the exterior pressure readings, and P_{TDRIFT} is a polynomial equation of the form a*(T_{REF}−T_{MEAS})²+b*(T_{REF}−T_{MEAS})+c, where a and b are unknown coefficients, c is an offset, T_{REF} is a reference exterior temperature and T_{MEAS} is the exterior temperature measured at the time of the exterior pressure sample. In some embodiments, given the error terms in calculating P_{ACT}, P_{TDRIFT} may be orders of magnitude larger than the actual differential pressure when calculating the differential pressure between an individual exterior pressure sensor and one or more interior pressure sensors. Accordingly, it may not be possible to calculate the drift coefficients when looking at a few data points. However, in some embodiments, given that the exterior and interior pressure sensors are in fixed locations and data is sampled throughout the day under various temperature conditions, eventually the data sampling size increases for each exterior temperature until the error terms follow a normal distribution.

In some embodiments, once the error terms follow a normal distribution, the differential building pressure may be calculated as P_{DIFF}=P_{IN}−P_{OUT}−P_{HOFF}, where P_{DIFF} is the calculated differential pressure, P_{IN} is the measured pressure for the interior device, Pour is the measured pressure for the exterior device, and P_{HOFF} is the differential offset between the two devices due to elevation differences. Moreover, if there were no drift due to temperature (i.e., P_{TDRIFT}=0), then a plot of differential pressure versus exterior temperature would not follow a curve. Therefore, in some embodiments, the coefficients for an individual exterior pressure sensor (i.e., a and b when calculating P_{TDRIFT}) can be deduced by using a multivariate linear regression model to minimize the standard deviation in the differential pressure versus exterior temperature.

Although the differential building pressure may be calculated based on only a single pressure sensor on each of the interior device and the exterior device, the P_{RMS} term may still be too large to calculate a reasonable differential building pressure. Thus in some embodiments, calibration is performed on each individual exterior pressure sensor and then the results are averaged, further reducing P_{RMS} and making accurate differential pressure readings possible.

In some embodiments, each exterior pressure sensor has its own long term drift. Although there is no means to distinguish each exterior sensor's long term drift due to environmental conditions when using only a single absolute pressure sensor on both the interior and exterior devices, it is possible to calculate an individual exterior sensor's long term drift if there are a plurality of interior and exterior pressure sensors.

In some embodiments, long-term drift is first analyzed if an exterior pressure sensor's pressure reading has drifted more than statistically expected from the mean of the plurality of exterior pressure sensors. Furthermore, the system may determine whether the exterior pressure sensors and the interior pressure sensors have experienced the same long-term drift. In some embodiments, the exterior pressure sensor's offset is adjusted to remove any calculated long term drift from the exterior pressure sensor's pressure readings.

In step 122 of method 116, building pressurization is calculated based on a difference between the interior pressure value and the exterior pressure value. In some embodiments, calculation of the building pressurization is based on an identified difference in elevation between pressure sensors. For example, one or more exterior pressure sensors may be mounted in a position of higher elevation (e.g., a roof of a building) and one or more interior pressure sensors may mounted in a position of lower elevation (e.g., an interior wall of a building). Accordingly, calculation of the building pressurization may take the difference in elevation of the sensors into account when calculating the difference between the interior pressure value and the exterior pressure value.

In step 124 of method 116, a building condition is identified based at least in part on the building pressurization. In some embodiments, identification of the building condition is further based on humidity, temperature, and/or CO2 levels. For example, a high building pressure, building pressure spikes, or an ongoing increase in building pressure may be identified based on the building pressurization, humidity, temperature, and/or CO2 levels.

Moreover, in some embodiments, identification of the building condition is further based on carbon monoxide levels, power (kW), energy (kWh), smoke/particulates, noise, light level, or odors. For example, light level may be used to identify a hazardous building condition associated with lighting, e.g., too little light in a restaurant or bar could cause people to fall down a step. As another example, noise level may be used to identify an unpleasant or noisy building condition, e.g., too much noise can cause people to not hear their conversations and not enjoy their experience. Furthermore, odor levels may be used to identify building conditions associated with unpleasant olfactory stimuli, e.g., restroom and sewer odors can be offensive and cause negative advertising on social media. In yet another example, smoke levels may also be used to identify unpleasant or hazardous building conditions, e.g., too much smoke in a bar or factory can cause cancer and breathing issues.

In step 126 of method 116, one or more corrective actions are performed based on the identification of the building condition. In some embodiments, maintenance is scheduled including the one or more corrective actions. For example, a corrective action of replacing an HVAC filter may be performed based on identifying a gradually decreasing building pressure. As another example, the fan may be changed from an automatic mode to a constant on mode based on identifying a building pressure spiking condition (i.e., intermittent increases in building pressure). In yet another example, supply settings may be adjusted in response to identifying building pressure increases during cooking times at a restaurant.

According to some embodiments of the invention, a method, system, and computer program product is provided of monitoring a building pressurization without penetrating an envelope of a building. In embodiments, at least one interior pressure signal and at least one exterior pressure signal are received from multiple pressure sensors, including at least one interior pressure sensor located on an interior of the envelope of the building and at least one exterior pressure sensor located on an exterior of the envelope of the building (i.e., outside of the interior of the envelope of the building).

In some embodiments, an interior pressure value is determined based on the at least one interior pressure signal, an exterior pressure value is determined based on the at least one exterior pressure signal, and the building pressurization is calculated based on a difference between the interior pressure value and the exterior pressure value. In some embodiments, at least one of the interior pressure and exterior pressure signals are received wirelessly. In some embodiments, a building condition is identified based on the building pressurization and one or more corrective actions are performed based on the identification of the building condition.

In some embodiments, a difference in elevation between the at least one interior pressure sensor and the at least one exterior pressure sensor may be identified, and the building pressurization may be based at least in part on the identified difference in elevation.

In some embodiments, the interior pressure sensors are absolute pressure sensors. Moreover, there may be multiple interior pressure sensors and the interior pressure value may be based on an average of the interior pressure sensors. In some embodiments, the interior pressure sensors may be calibrated, including identifying a drift of at least one of the interior pressure sensors, and the interior pressure value may be based at least in part on the identified drift. For example, a particular interior pressure sensor may be identified as erroneous based on a deviation of a reading of the particular interior pressure sensor from readings of a remainder of the interior pressure sensors, and the interior pressure value may be based on an average of the remainder of the interior pressure sensors.

In some embodiments, the exterior pressure sensors are absolute pressure sensors. Moreover, there may be multiple exterior pressure sensors, and the exterior pressure value may be based on an average of the exterior pressure sensors. In some embodiments, the exterior pressure sensors may be calibrated, including identifying a drift of at least one of the exterior pressure sensors, and the exterior pressure value may be based at least in part on the identified drift. For example, a particular exterior pressure sensor may be identified as erroneous based on a deviation of a reading of the particular exterior pressure sensor from readings of a remainder of the exterior pressure sensors, and the exterior pressure value may be based on an average of the remainder of the exterior pressure sensors.

In some embodiments, a building condition may be identified based at least in part on a signal from one or more of the following signals: a carbon monoxide signal from a carbon monoxide sensor, a power signal from a power sensor, an energy signal from an energy sensor, a smoke or particulates signal from a smoke or particulates sensor, a noise signal from a sound sensor, a light level signal from a light sensor, and an odor signal from an odor sensor. For example, a humidity signal may be received from at least one humidity sensor, a humidity value may be determined based on the received humidity signal, and the building condition way be identified based at least in part on the humidity value. As another example, a temperature signal may be received from at least one temperature sensor, a temperature value may be determined based on the received temperature signal, and the building condition way be identified based at least in part on the temperature value. In another example, a carbon dioxide signal may be received from at least one carbon dioxide sensor, a carbon dioxide value may be determined based on the received carbon dioxide signal, and the building condition may be identified based at least in part on the carbon dioxide value.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a communication network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method for monitoring a building pressurization without penetrating an envelope of a building, the method comprising:
receiving at least one interior pressure signal and at least one exterior pressure signal from a plurality of pressure sensors, wherein
the plurality of pressure sensors include at least one interior pressure sensor located on an interior of the envelope of the building, and
the plurality of pressure sensors include at least one exterior pressure sensor located on an exterior of the envelope of the building;
determining an interior pressure value based on the at least one interior pressure signal;
determining an exterior pressure value based on the at least one exterior pressure signal;
calculating the building pressurization based on a difference between the interior pressure value and the exterior pressure value, wherein at least one of the at least one interior pressure signal and the at least one exterior pressure signal are received wirelessly; and
identifying a building condition based at least in part on the building pressurization.

2. The method of claim 1 further comprising:
performing one or more corrective actions based on the identification of the building condition.

3. The method of claim 1 wherein the at least one interior pressure sensor comprises a plurality of interior pressure sensors and the interior pressure value is based on an average of the plurality of interior pressure sensors, and the at least one exterior pressure sensor comprises a plurality of exterior pressure sensors and the exterior pressure value is based on an average of the plurality of exterior pressure sensors.

4. The method of claim 3 further comprising:
calibrating the plurality of interior pressure sensors; and
calibrating the plurality of exterior pressure sensors.

5. The method of claim 4 wherein the plurality of interior pressure sensors are calibrated based upon a first comparison of the plurality of interior pressure sensors with the plurality of exterior pressure sensors, and the plurality of exterior pressure sensors are calibrated based upon a second comparison of the plurality of exterior pressure sensors with the plurality of interior pressure sensors.

6. The method of claim 3 further comprising:
identifying a first drift of at least one of the plurality of interior pressure sensors, wherein the interior pressure value is based at least in part on the first drift; and
identifying a second drift of at least one of the plurality of exterior pressure sensors, wherein the exterior pressure value is based at least in part on the second drift.

7. The method of claim 6 wherein the first drift is identified based upon a first comparison of the plurality of interior pressure sensors with the plurality of exterior pressure sensors, and the second drift is identified based upon a second comparison of the plurality of exterior pressure sensors with the plurality of interior pressures sensors.

8. The method of claim 3 further comprising:
identifying a particular interior pressure sensor of the plurality of interior pressure sensors as erroneous based on a first deviation of a reading of the particular interior pressure sensor from readings of a remainder of the plurality of interior pressure sensors, wherein the interior pressure value is based on an average of the remainder of the plurality of interior pressure sensors; and
identifying a particular exterior pressure sensor of the plurality of exterior pressure sensors as erroneous based on a second deviation of a reading of the particular exterior pressure sensor from readings of a remainder of the plurality of exterior pressure sensors, wherein the exterior pressure value is based on an average of the remainder of the plurality of exterior pressure sensors.

9. The method of claim 2 wherein the building condition is identified based at least in part on a signal selected from the group consisting of:
a humidity signal from at least one humidity sensor
a temperature signal from at least one temperature sensor
a carbon dioxide signal from at least one carbon dioxide sensor
a carbon monoxide signal from a carbon monoxide sensor,
a power signal from a power sensor,
an energy signal from an energy sensor,
a smoke or particulates signal from a smoke or particulates sensor,
a noise signal from a sound sensor,
a light level signal from a light sensor, and
an odor signal from an odor sensor.

10. A system for monitoring a building pressurization without penetrating an envelope of a building, the system comprising:
a processor; and
a memory including instructions that, when executed by the processor, cause the system to:
receive at least one interior pressure signal and at least one exterior pressure signal from a plurality of pressure sensors, wherein
the plurality of pressure sensors include at least one interior pressure sensor located on an interior of the envelope of the building, and
the plurality of pressure sensors include at least one exterior pressure sensor located on an exterior of the envelope of the building;
determine an interior pressure value based on the at least one interior pressure signal;
determine an exterior pressure value based on the at least one exterior pressure signal;
calculate the building pressurization based on a difference between the interior pressure value and the exterior pressure value, wherein at least one of the at least one interior pressure signal and the at least one exterior pressure signal are received wirelessly; and
identify a building condition based at least in part on the building pressurization.

11. The system of claim 10 wherein the instructions are further configured to cause the system to identify one or more corrective actions based on the identification of the building condition.

12. The system of claim 10 wherein the at least one interior pressure sensor comprises a plurality of interior pressure sensors and the interior pressure value is based on an average of the plurality of interior pressure sensors, and the at least one exterior pressure sensor comprises a plurality of exterior pressure sensors and the exterior pressure value is based on an average of the plurality of exterior pressure sensors.

13. The system of claim 12 wherein the instructions are further configured to cause the system to:
calibrate the plurality of interior pressure sensors; and
calibrate the plurality of exterior pressure sensors.

14. The system of claim 13 wherein the plurality of interior pressure sensors are calibrated based upon a first comparison of the plurality of interior pressure sensors with the plurality of exterior pressure sensors, and the plurality of exterior pressure sensors are calibrated based upon a second comparison of the plurality of exterior pressure sensors with the plurality of interior pressure sensors.

15. The system of claim 12 wherein the instructions are further configured to cause the system to:
identify a first drift of at least one of the plurality of interior pressure sensors, wherein the interior pressure value is based at least in part on the first drift; and
identify a second drift of at least one of the plurality of exterior pressure sensors, wherein the exterior pressure value is based at least in part on the second drift.

16. The system of claim 15 wherein the first drift is identified based upon a first comparison of the plurality of interior pressure sensors with the plurality of exterior pressure sensors, and the second drift is identified based upon a second comparison of the plurality of exterior pressure sensors with the plurality of interior pressures sensors.

17. The system of claim 12 wherein the instructions are further configured to cause the system to:
identify a particular interior pressure sensor of the plurality of interior pressure sensors as erroneous based on a first deviation of a reading of the particular interior pressure sensor from readings of a remainder of the plurality of interior pressure sensors, wherein the interior pressure value is based on an average of the remainder of the plurality of interior pressure sensors; and
identify a particular exterior pressure sensor of the plurality of exterior pressure sensors as erroneous based on a second deviation of a reading of the particular exterior pressure sensor from readings of a remainder of the plurality of exterior pressure sensors, wherein the exterior pressure value is based on an average of the remainder of the plurality of exterior pressure sensors.

18. The system of claim 10 wherein the building condition is identified based at least in part on a signal selected from the group consisting of:
a humidity signal from at least one humidity sensor
a temperature signal from at least one temperature sensor
a carbon dioxide signal from at least one carbon dioxide sensor
a carbon monoxide signal from a carbon monoxide sensor,
a power signal from a power sensor,
an energy signal from an energy sensor,
a smoke or particulates signal from a smoke or particulates sensor,
a noise signal from a sound sensor,
a light level signal from a light sensor, and
an odor signal from an odor sensor.

19. A computer program product for monitoring a building pressurization without penetrating an envelope of a building, the computer program product comprising:
a non-transitory computer-readable storage medium; and
instructions stored on the non-transitory computer-readable storage medium that, when executed by a processor, causes the processor to:
receive at least one interior pressure signal and at least one exterior pressure signal from a plurality of pressure sensors, wherein
the plurality of pressure sensors include at least one interior pressure sensor located on an interior of the envelope of the building, and
the plurality of pressure sensors include at least one exterior pressure sensor located on an exterior of the envelope of the building;
determine an interior pressure value based on the at least one interior pressure signal;
determine an exterior pressure value based on the at least one exterior pressure signal;
calculate the building pressurization based on a difference between the interior pressure value and the exterior pressure value, wherein at least one of the at least one interior pressure signal and the at least one exterior pressure signal are received wirelessly; and
identify a building condition based at least in part on the building pressurization.

20. The computer program product of claim 19 wherein the instructions are further configured to cause the processor to identify one or more corrective actions based on the identification of the building condition.
